(19) United States
(12) Patent Application Publication
(10) Pub. No.: US 2017/0135150 A1
(43) Pub. Date: May 11, 2017

(54) IMPROVED DRX CONFIGURATION

(71) Applicant: TELEFONAKTIEBOLAGET LM ERICSSON (PUBL), Stockholm (SE)

(72) Inventors: Alexander LANGEREIS, Sigtuna (SE); Prabaharan KANESALINGAM, Ottawa (CA)

(21) Appl. No.: 15/319,119

(22) PCT Filed: Jul. 1, 2014
(86) PCT No.: PCT/EP2014/063974

§ 371 Date: Dec. 15, 2016

(51) Int. Cl. H04W 76/04; H04W 28/26; H04W 72/04; H04L 12/18; H04W 52/02

(52) U.S. Cl. CPC H04W 76/048; H04L 12/189; H04W 52/0235; H04W 72/0446; H04W 28/26

(57) ABSTRACT

A method in communications network. Downlink transmissions to a user equipment, UE, are scheduled with reserved subframes for one or more specified services. An amount of overlap between wake periods of a default discontinuous reception, DRX, configuration for the UE and said reserved subframes is determined, and it is then determined that the amount of overlap exceeds a threshold. In response a configuration signal is sent to the UE, the configuration signal configuring the UE to use an extended DRX configuration having wake periods of greater duration than the wake periods of the default DRX configuration.

### TECHNICAL FIELD

The invention relates to improvements in the configuration of discontinuous reception, DRX, in a mobile telephone network. In particular, the invention relates to methods and apparatus for providing improved DRX configuration in the case where a basestation has certain subframes reserved for specific services.

### BACKGROUND

### Discontinuous Reception (DRX)

In mobile communications networks, discontinuous reception (DRX) is used to reduce battery consumption in the user equipment (UE). FIG. 1A shows an example of a DRX configuration. The UE alternates between two modes, “wake”, in which the UE can receive data, and “sleep” in which the UE cannot receive data as the receiver circuit is powered down in order to conserve battery life (the terms “awake” and “asleep” are use to describe being in each state). The wake-sleep cycle is defined by various parameters, as specified in the standard (3GPP TS 36.331 V12.1.0), the most important of which are shown in FIG. 1A. “Long_DRX_Cycle” (A) defines the length of the DRX cycle, i.e. the time between each switch from “sleep” to “wake”. “On_Duration_Timer” (B) defines the minimum period for which each UE will be awake in each cycle, and “Inactivity_Timer” (C) defines the minimum period that the UE will be awake after receiving a packet or receiving grant for transmitting a packet on the physical uplink shared channel (PUSCH).

As an example, take the situation shown in FIG. 1B where Long_DRX_Cycle (A)=40 ms, On_Duration_Timer (B)=10 ms, and Inactivity_Timer (C)=5 ms. Defining the start of the first cycle as t=0 ms, the UE is initially expected to remain awake until t=10 ms, and to enter the sleep state at this time. If a packet (P1) is received a t=3 ms, the inactivity timer would run out at t=3 ms+5 ms=8 ms. Since this is before the expiry of the on duration timer, the UE would remain awake until t=10 ms. If a packet (P2) is then received at t=9 ms, the inactivity timer would run out at t=14 ms, so the UE remains in the wake state until t=14 ms (or longer if further packets are received in that time). If a packet P3 is then available to be sent from the basestation (more specifically, an eNodeB) to the UE at t=22 ms, it is queued up at the basestation until the next time the UE is awake. At t=40 ms, the on duration timer resets, and the UE re-enters the wake state if it was asleep. Any packets which were queued up by the basestation are then sent to the UE.

The DRX configuration is negotiated between the basestation and the UE at registration, and at establishment of any bearer (and for some bearer modifications), or at another occasion where a Radio Resource Control (RRC) Connected Reconfiguration is performed. The DRX configuration will be chosen to give a good balance between quality of service and battery life for the UE. For example, a typical DRX configuration for an idle UE would involve a much longer Long_DRX_Cycle than a DRX configuration for a UE which is engaged in a Voice over IP (VoIP) call. The On_Duration_Timer would be similar in each case, so the idle UE would require much less power for the receiver circuits.

### Voice over IP (VoIP)

VoIP services function by splitting the audio of a voice call into a number of packets, each of which contains a short segment of the overall audio (typically on the order of 20 ms). These are sent from the speaker's UE to the listener's UE, where they are reassembled. In order to ensure that the listener hears a continuous stream of audio (e.g. with no gaps, slowed down sections, or popping), there is some delay between the receiving of the packets at the listener's UE and playback, which is used to smooth out any variation in the rate at which audio is received. The total “mouth-to-ear” delay (i.e. the delay between audio being recorded at the speaker's UE, and played back at the listener's UE) is one of the main factors in determining speech quality. In order to provide slack time for smoothing out the audio at the listener's UE, the transmission time of packets through the network should be as low as possible.

In Long Term Evolution (LTE) networks, all packets are delivered using the IP protocol. This means that all voice calls on LTE networks use VoIP for LTE (VoLTE). VoLTE defines “delay budgets”, which specify the maximum delay that can be introduced between nodes of the network when transmitting VoLTE packets in order to maintain a good quality of service. The delay budget between the eNodeB and the UE is normally 80 ms. In order to balance battery consumption at the UE with this delay budget, a typical Long_DRX_Cycle for a UE involved in a VoLTE session is 40 ms. Since VoLTE packets are sent every 20 ms, this means that two speech packets will normally be sent by the eNodeB in each wake period, as shown in FIG. 1C. If a wake period is missed, then an additional delay of 40 ms in introduced, which makes it more difficult to transmit the packets within the delay budget (since other factors other than the time the packet is held at the basestation while the UE is asleep will add to the total delay).

### Evolved Multimedia Broadcast Multicast Service (eMBMS)

Evolved Multimedia Broadcast Multicast Service (eMBMS) is used in LTE networks to offer broadcast or multicast services. The service reserves specific subframes at the eNodeB for multimedia broadcast (each subframe lasts 1 ms). Depending on the amount of multicast content schedule to be transmitted, up to 6 of the 10 subframes in each radio frame can be configured for eMBMS. These subframes form the “Multi Broadcast Single Frequency Network” (MBSFN), and are reserved for eMBMS transmissions (i.e. cannot be used for unicast traffic such as VoLTE).

### SUMMARY

According to a first aspect, there is provided a method in communications network. Downlink transmissions to a user equipment, UE, are scheduled with reserved subframes for one or more specified services. An amount of overlap between wake periods of a default discontinuous reception, DRX, configuration for the UE and said reserved subframes is determined, and it is then determined that the amount of overlap exceeds a threshold. In response a configuration signal is sent to the UE, the configuration signal configuring the UE to use an extended DRX configuration having wake periods of greater duration than the wake periods of the default DRX configuration.

According to a second aspect, there is provided an apparatus comprising a radio transceiver, a downlink scheduling processor, a DRX scheduling processor, and a DRX configuration processor. The radio transceiver is configured to communicate with a user equipment, UE. The downlink scheduling processor is configured to schedule downlink transmissions on the transceiver, including scheduling reserved subframes for one or more specified services. The DRX scheduling processor is configured to determine an amount of overlap between wake periods of a default DRX configuration for the UE and said reserved subframes, and determine that the amount of overlap exceeds a threshold. The DRX configuration processor is configured to, in response to the determination that the amount of overlap exceeds a threshold, cause the transceiver to send a configuration signal to the UE, the configuration signal configuring the UE to use an extended DRX configuration having wake periods of greater duration than the wake periods of the default DRX configuration.

According to a third aspect, there is provided a computer program, comprising instructions which, when executed on at least one processor, cause the at least one processor to carry out the method according to the first aspect. The computer program may be carried on any one of an electronic signal, optical signal, radio signal, or a non-transitory computer readable storage medium.

### BRIEF DESCRIPTION OF THE DRAWINGS

FIGS. 1 A, B and C illustrate discontinuous reception;

FIG. 2 shows an overlap between MBSF subframes and DRX wake periods;

FIGS. 3 A and B are flowcharts of methods according to embodiments;

FIG. 4 is a flowchart of a method according to a further embodiment; and

FIG. 5 is a schematic diagram of a basestation.

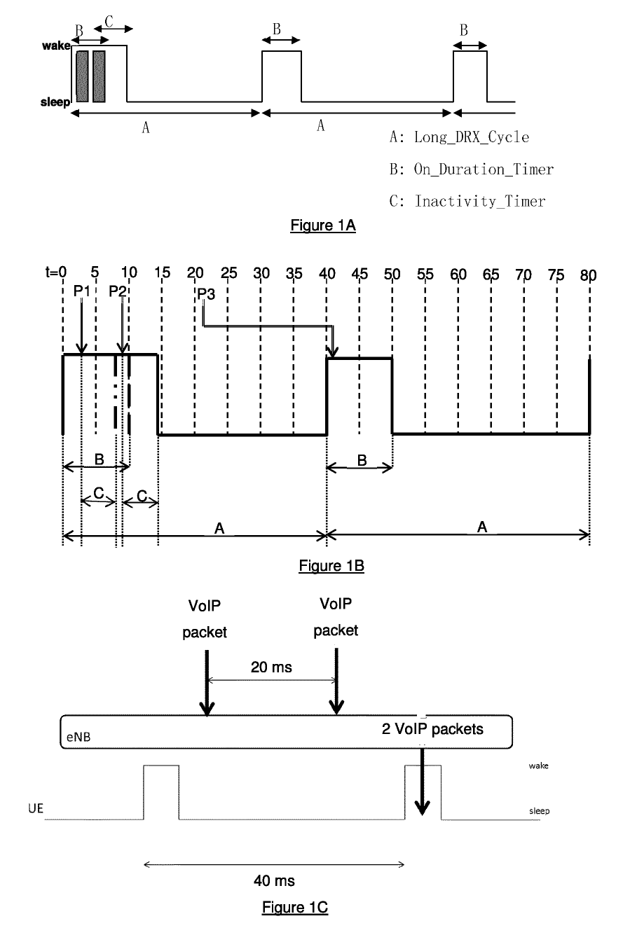

### DETAILED DESCRIPTION

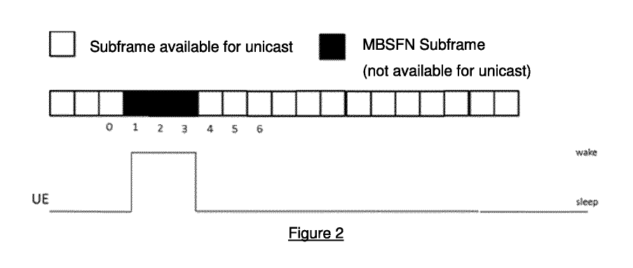

In situations where eMBMS co-exists with DRX, the available subframes for downlink transmission of unicast packets (e.g. VoLTE) are reduced by both eMBMS and DRX. Since both features reduce the possible subframes in which the unicast packets can be transmitted, a combination of the two features can result in very few or even zero subframes being available for downlink transmission during a DRX cycle. This problem would also occur for services other than eMBMS which restrict the types of packets which can be sent on certain reserved subframes. An example of this overlap is shown in FIG. 2.

A solution is proposed below in order to overcome the above problem. The solution requires new functionality only in the basestation (the term is used herein to include eNodeBs). No extra communication is required for other nodes of the network, aside from the UE, and the altered signalling sent to the UE can be handled by standard software in the UE.

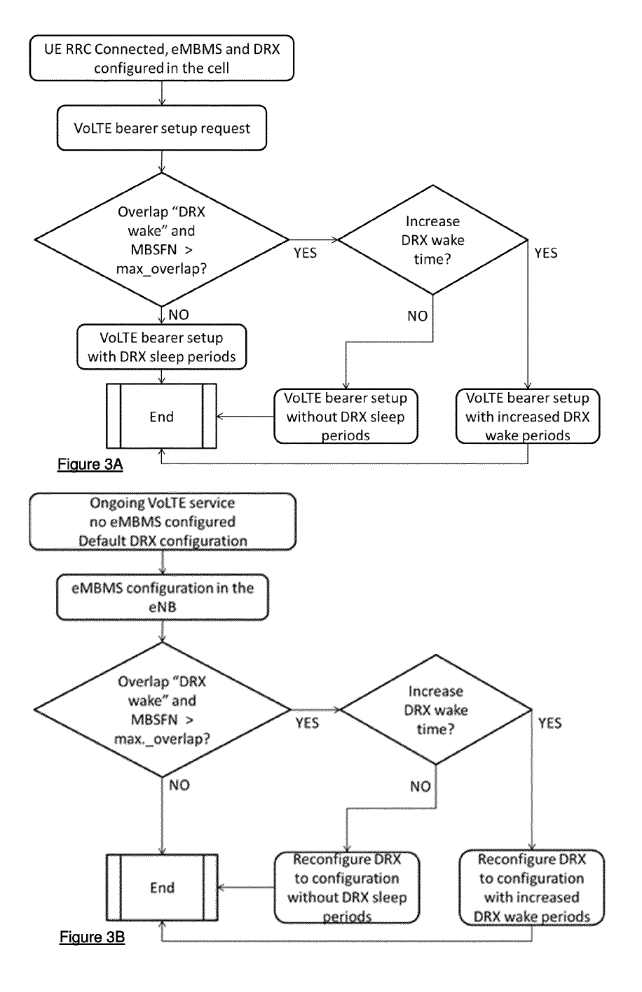

A flowchart of the method is show in FIGS. 2A and B. The method is triggered when the basestation has reserved subframes scheduled, and has UEs with DRX enabled scheduled. This could occur either when a UE initiates a session or otherwise triggers a new DRX configuration while the basestation has reserved subframes scheduled (FIG. 3A) or when reserved subframes (e.g. for eMBMS) are first scheduled (FIG. 3B). The basestation determines an amount of overlap between scheduled reserved subframes and the DRX configuration of the UE. In the case where the method is triggered by the UE initiating a session or otherwise causing an adjustment in DRX configuration, the relevant DRX configuration is the default DRX configuration that would be scheduled for the UE. In the case where the method is triggered by the scheduling of reserved subframes, the relevant DRX configuration is the current DRX configuration of the UE (where the “default DRX configuration” is referred to, this can be taken to include the current DRX configuration in this case). If the overlap between the DRX wake times and the reserved subframes exceeds a threshold, then the basestation sends an “extended” DRX configuration to the UE, with increased wake periods compared to the default DRX configuration. If the overlap does not exceed a threshold, then the basestation sends the default DRX configuration, or does not send a new DRX configuration if the UE is already using the default DRX configuration.

Considering further how the method is triggered, in the case where the UE initiates a session or otherwise triggers a new DRX configuration, the method may be triggered for all such requests, or only for UEs using a subset of services. For example, the method may not be triggered if the UE initiates a session for a service which is allowed in the reserved subframes, and/or the method may only be triggered for certain services for which a relatively high quality of service is required (e.g. real time or near real time services). Similarly, when reserved subframes are first scheduled, the method may be triggered for all UEs, or only for UEs using a subset of services. This would allow the basestation to avoid having to perform the method for UEs which would only gain marginal benefit from the extended DRX configuration, and avoids causing higher than necessary drain on the battery of UEs which are running services which do not require a high quality of service.

Alternatively, the threshold for the overlap between the DRX wake times and the reserved subframes may depend on the service(s) in use by the UE. For example, a UE involved in a voice call may have a lower overlap threshold than a UE involved in a file transfer, and both may have a lower overlap threshold than a UE which is not currently involved in any sessions.

The overlap between the DRX wake times and the reserved subframes may be determined in a variety of ways. In one embodiment, the overlap may be determined by comparing the total overlap of DRX wake times and reserved subframes over many DRX cycles, e.g. over all frames for which the reserved subframe schedule has been determined. The resulting overlap may be expressed as a ratio. However, this method will not identify many problematic overlaps. For example, if the schedule is determined for the next 1000 DRX cycles, and 980 of those cycles have no overlap, but 20 consecutive cycles overlap entirely with reserved subframes, then this embodiment would only show a 2% overlap, which would likely be considered acceptable, even though there would be considerable disruption of service for the 20 cycles which overlap completely.

The threshold at which the overlap is determined to be unacceptable may be set so that it is exceeded when performance of the service running on the UE would be likely to be affected by the overlap.

In a further embodiment, an overlap may be determined for each DRX cycle for which subframe scheduling information is available, and the contribution of each cycle to the overall overlap may be weighted non-linearly, e.g. with cycles with a greater individual overlap contributing more to the overall overlap measurement than would be expected if the weighting were linear. As an example, if there was a DRX cycle with a 10% overlap and a DRX cycle with a 50% overlap, the DRX cycle with a 50% overlap may contribute more than 5 times the amount that the DRX cycle with a 10% overlap contributes to the overall overlap measurement.

In a further embodiment, an overlap may be determined for each DRX cycle, and these overlaps may be compared individually to a threshold.

In any of the above embodiments, the comparison may be weighted depending on where the reserved subframes overlap with the DRX wake period. For example, an overlap at the start of a DRX wake period may be weighted less heavily than an overlap at the end of a DRX wake period, as the overlap at the start is more likely to be naturally compensated for on a default configuration by the inactivity timer. As a further optional feature, reserved subframes that occur after the on duration timer expires may be considered at a reduced weight, e.g. depending on the time between the expiry of the on duration timer and the reserved subframe and the length of the inactivity timer.

If the basestation determines that the overlap exceeds a threshold, then an “extended” DRX configuration will be provided to the UE. The extended DRX configuration will have longer wake times than that standard DRX configuration, either through increasing the On_Duration_Timer, the Inactivity_Timer, another suitable variable, or some combination of multiple variables. The wake time will be increased in order to ensure that there is an acceptable amount of time available for transmission of data to the UE in all or a majority of DRX cycles. The exact configuration used may depend on the level of overlap. For example, the extended DRX configuration may be such that where the overlap is between 30 and 75% for a DRX cycle, the extended configuration may set the Inactivity_Timer such that if a packet is received while the UE is awake, the overlap would decrease to below 30%, and where the overlap is about 75%, the extended configuration may additionally set the On_Duration_Timer such that the overlap is reduced below 75%.

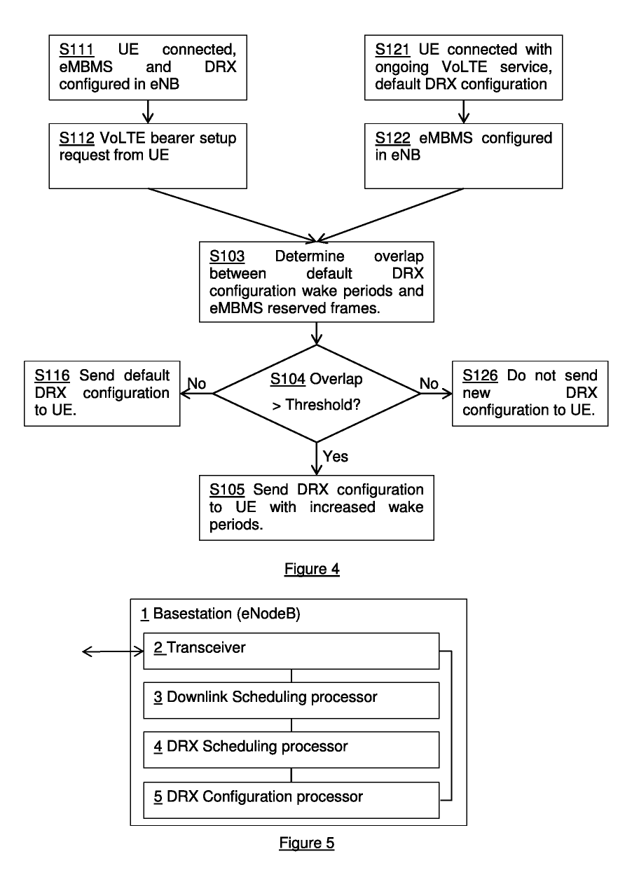

FIG. 4 is a flowchart of the method described above, and FIG. 5 is a schematic of a basestation suitable for implementing the method. The basestation (1) comprises a radio transceiver (2), a downlink scheduling processor (3), a DRX scheduling processor (4) and a DRX configuration processor (5). The radio transceiver (2) is configured to communicate with the UE. The downlink scheduling processor (3) is configured to schedule downlink transmissions on the transceiver. The method may be triggered in one of two ways, shown as S111/S112 and S121/S122. In the first option, the downlink scheduling processor (3) has already scheduled reserved subframes (e.g. eMBMS) on the transceiver (S111), and a new bearer, e.g. a VoLTE bearer request is received from the UE (S121). In the second option, the UE is already connected with an ongoing session, e.g. VoLTE, using a default DRX configuration (S111), and the downlink scheduling processor (3) schedules reserved subframes (e.g. eMBMS) on the transceiver (S121).

Following the method being triggered, the DRX scheduling processor (4) determines an overlap between the reserved subframes and the wake periods of the default DRX configuration (i.e. the configuration that would normally be applied to the UE, or the configuration the UE is currently using if there is already an ongoing session) (S103). The DRX scheduling processor (4) then determines whether the overlap exceeds a threshold (S104). If the overlap exceeds the threshold, then the DRX configuration processor (5) causes the transceiver to send a configuration signal to the UE, the configuration signal configuring the UE to use an extended DRX configuration having wake periods of greater duration than the wake periods of the default DRX configuration (S105). If the overlap does not exceed the threshold, then if the UE is not currently on the default DRX configuration, the DRX configuration processor causes the transceiver to send a configuration signal to the UE, the configurations signal configuring the UE to use the default DRX configuration (S116). If the overlap does not exceed the threshold and the UE is currently on the DRX configuration, no configuration signal needs to be sent.

The method disclosed above may be implemented as a computer program, comprising instructions which, when executed on at least one processor, cause the at least one processor to carry out the method. The computer program may be carried on any one of an electronic signal, optical signal, radio signal, or a non-transitory computer readable storage medium

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. For example, while the method is described herein as being performed at a basestation, the skilled person will appreciate that the method could be performed at another node with access to the DRX configuration of the UE, and the scheduling information for the basestation.

Similarly, the method could be performed at nodes equivalent to the basestation in other network architectures. Each feature disclosed or illustrated in the present specification may be incorporated in the invention, whether alone or in any appropriate combination with any other feature disclosed or illustrated herein.

1. A method in communications network, wherein downlink transmissions to a user equipment, UE, are scheduled with reserved subframes for one or more specified services, the method comprising:
determining an amount of overlap between wake periods of a default discontinuous reception, DRX, configuration for the UE and said reserved subframes;
determining that the amount of overlap exceeds a threshold and, in response:
sending a configuration signal to the UE, the configuration signal configuring the UE to use an extended DRX configuration having wake periods of greater duration than the wake periods of the default DRX configuration.

2. A method according to claim 1, wherein the method is performed in response to detecting establishment of a session involving the UE.

3. A method according to claim 2, wherein said session is a voice over IP, VoIP, session or a voice over LTE, VoLTE, session.

4. A method according to claim 1, wherein the method is performed in response to scheduling of reserved subframes, and wherein the UE is configured with the default DRX configuration prior to the step of determining the amount of overlap.

5. A method according to claim 1, wherein the one or more specified services comprise multimedia broadcast multicast service, MBMS, and/or evolved MBMS, eMBMS.

6. A method according to claim 1, wherein said extended DRX configuration is configured to cause the UE to remain in the wake state permanently.

7. A method according to claim 1, wherein said extended DRX configuration is configured to cause the UE to remain in the wake state for at least a predetermined period of time after the reserved subframes.

8. A method according to claim 1, wherein the method is performed in a basestation or an evolved NodeB, eNodeB.

9. An apparatus comprising:
a radio transceiver configured to communicate with a user equipment, UE;
a downlink scheduling processor configured to schedule downlink transmissions on the transceiver, including scheduling reserved subframes for one or more specified services;
a discontinuous reception, DRX, scheduling processor configured to determine an amount of overlap between wake periods of a default DRX configuration for the UE and said reserved subframes, and determine that the amount of overlap exceeds a threshold;
a DRX configuration processor configured to, in response to the determination that the amount of overlap exceeds a threshold, cause the transceiver to send a configuration signal to the UE, the configuration signal configuring the UE to use an extended DRX configuration having wake periods of greater duration than the wake periods of the default DRX configuration.

10. An apparatus according to claim 9, wherein the DRX scheduling processor is configured to perform the steps of determining in response to detecting establishment of a session involving the UE.

11. An apparatus according to claim 10, wherein said session is a voice over IP, VoIP, session or a voice over LTE, VoLTE, session.

12. An apparatus according to claim 9, wherein the DRX scheduling processor is configured to perform the steps of determining in response to scheduling of reserved subframes by the downlink scheduling processor.

13. An apparatus according to claim 9, wherein the one or more specified services comprise multimedia broadcast multicast service, MBMS, and/or evolved MBMS, eMBMS.

14. An apparatus according to claim 9, wherein the extended DRX configuration is configured to cause the UE to remain in the wake state permanently.

15. An apparatus according to claim 9, wherein the extended DRX configuration is configured to cause the UE to remain in the wake state for at least a predetermined period of time after the reserved subframes.

16. An apparatus according to claim 9, and configured to operate as a basestation or an evolved NodeB, eNodeB.

17. A computer program, comprising instructions which, when executed on at least one processor, cause the at least one processor to carry out the method according to claim 1.

18. A carrier containing the computer program of claim 17, wherein the carrier is one of an electronic signal, optical signal, radio signal, or a non-transitory computer readable storage medium.
